(19) United States
(12) Patent Application Publication
(10) Pub. No.: US 2023/0244949 A1
(43) Pub. Date: Aug. 3, 2023

(54) METHODS AND SYSTEMS TO TRAIN NEURAL NETWORKS

(71) Applicant: THE BOARD OF REGENTS OF THE UNIVERSITY OF TEXAS SYSTEM, Austin, TX (US)

(72) Inventors: Milo M. LIN, Dallas, TX (US); Paul J. BLAZEK, Irving, TX (US)

(73) Assignee: THE BOARD OF REGENTS OF THE UNIVERSITY OF TEXAS SYSTEM, Austin, TX (US)

(21) Appl. No.: 17/801,175

(22) PCT Filed: Feb. 24, 2021
(86) PCT No.: PCT/US2021/019470

§ 371 Date: Aug. 19, 2022

Related U.S. Application Data
(60) Provisional application No. 62/980,687, filed on Feb. 24, 2020.

(51) Int. Cl. G06N 3/09; G06N 3/088; G06N 3/082; G06N 3/084

(52) U.S. Cl. CPC G06N 3/09; G06N 3/082; G06N 3/084; G06N 3/088

(57) ABSTRACT

A computer-implemented technique for training an artificial neural network is disclosed. The technique includes obtaining a training sample for training the artificial neural network; determining multiple sub concepts within the training sample; processing the sub concepts to obtain differential neurons associated with the sub concepts, wherein the differential neurons provide a relative distinction between the sub concepts; integrating the differential neurons to obtain sub concepts neurons, wherein the sub concepts neurons provide an absolute distinction of sub concepts; and integrating the sub concepts neurons to obtain concept neurons that form an output of the neural network.

### CROSS-REFERENCE TO RELATED APPLICATIONS

This application is a U.S. National Stage Application of International Application No. PCT/US2021/019470, filed Feb. 24, 2021, which claims priority to U.S. Provisional Application No. 62/980,687 filed Feb. 24, 2020, each of the forgoing are hereby incorporated by reference in their entireties.

### FIELD

The present disclosure relates to methods and systems to train neural networks.

### BACKGROUND

A defining feature of living systems is the ability to integrate multiple signals and respond appropriately. It is often difficult to understand these processes mechanistically because they involve multiple, distributed agents. For human cognition, the ancient question of how the brain gives rise to thought has been embodied during the last century in the divide between symbolic cognitive models and connectionist network models.

On the one hand, symbolic models of reasoning have historically been phenomenological and therefore have lacked a direct mechanistic link to the brain’s neuronal structure. On the other hand, connectionist models of neural networks have been unable to explain the emergence of conceptual thought and symbolic manipulation.

The divide between symbolism and connectionism has been especially evident in their various implementations in artificial intelligence (AI) systems. Recent attempts at capturing symbolic reasoning in connectionist models do not address this divide because they are hybrids in which symbolic work only occurs on the outputs of networks, ignoring the need to integrate symbolic manipulation within the network itself.

Because of this divide, both symbolic and connectionist AI currently have other fundamental limitations. Symbolic AI often proves too rigid, does not scale well to combinatorically large problems, and is not able to learn features from raw input data.

Recently, connectionist deep learning models have become popular due to their superhuman accuracy across a large range of tasks. This known approach utilizes artificial neural networks with layers of biologically inspired neurons, which they train by gradient descent (GD) with backpropagation. Despite its success, it is widely regarded as a black box because there appears to be no understandable explanation for the learned synaptic weights or for the process by which individual neurons give rise to the final output.

Deep learning techniques also have difficulty generalizing and therefore require large labeled datasets. And the networks are paradoxically fooled by adversarial attacks with small, human-imperceptible input perturbations. More fundamentally, various biological phenomena such as modularity, hubs, and sparse neuron firing are not naturally learned by artificial neural networks. Much effort has been devoted to addressing these problems, yet they remain largely unresolved.

It is an object of the present disclosure to provide methods and systems to train neural networks that overcome these limitations.

### SUMMARY

A computer-implemented method for training an artificial neural network is disclosed. The method includes obtaining a training sample for training the artificial neural network; determining multiple sub concepts within the training sample; processing the sub concepts to obtain differential neurons associated with the sub concepts, wherein the differential neurons provide a relative distinction between the sub concepts; integrating the differential neurons to obtain sub concepts neurons, wherein the sub concepts neurons provide an absolute distinction of sub concepts; and integrating the sub concepts neurons to obtain concept neurons that form an output of the neural network.

The training sample may be designed to teach one or more rules. The determining of the sub concepts within the training sample may include obtaining various subsets of the training sample and distinguishing between the various subsets. The unsupervised learning may be used to determine hierarchical structure of the sub concepts. The sub concepts may be overlapping or hierarchically structured. One or more of the differential neurons may be pruned before the integrating of the differential neurons to obtain sub concepts neurons. The neurons of the artificial neural network can be deliberative, temporarily changing their parameters. The artificial neural network can be tuned after the training to improve its performance. The neurons of the artificial neural network may provide symbolic outputs that are interpretable as algorithms.

A system for training a neural network is disclosed. The system comprises a processor and an associated memory, the processor being configured to: obtain a training sample for training the artificial neural network; determine multiple sub concepts within the training sample; process the sub concepts to obtain differential neurons associated with the sub concepts, wherein the differential neurons provide a relative distinction between the sub concepts; integrate the differential neurons to obtain sub concepts neurons, wherein the sub concepts neurons provide an absolute distinction of sub concepts; and integrate the sub concepts neurons to obtain concept neurons that form an output of the neural network.

### BRIEF DESCRIPTION OF DRAWINGS

Other objects and advantages of the present disclosure will become apparent to those skilled in the art upon reading the following detailed description of exemplary embodiments, in conjunction with the accompanying drawings, in which like reference numerals have been used to designate like elements, and in which:

FIG. 1 shows a flowchart for training a neural network according to an exemplary embodiment of the present disclosure;

FIG. 2 shows the disclosed model being applied to fruits and vegetables according to an exemplary embodiment of the present disclosure;

FIGS. 3A and 3E, show a set of diagrams that illustrate that ENNs are scalable in performance and training time according to one or more example embodiments of the present disclosure;

FIGS. 4A and 4B, illustrate that convolutional ENNs learn more explainable features according to one or more example embodiments of the present disclosure;

FIGS. 5A-5G, show a set of diagrams that illustrate that ENN weights are explainable, sparse, and modular according to one or more example embodiments of the present disclosure;

FIGS. 6A-6F, show a set of diagrams that illustrate ENN weights are explainable, sparse, and modular according to one or more example embodiments of the present disclosure;

FIG. 7 illustrates that ENN neurons integrate distributed and localized firing patterns according to one or more example embodiments of the present disclosure;

FIGS. 8A-8J, show a set of diagrams that illustrate ENNs implement symbolic manipulation and generalize rules for different problems according to one or more example embodiments of the present disclosure;

FIGS. 9A and 9B, illustrate that GDNs of different network sizes cannot blindly generalize according to one or more example embodiments of the present disclosure;

FIGS. 10A and 10B, illustrate improbability of GDNs finding blindly generalizing networks according to one or more example embodiments of the present disclosure;

FIGS. 11A-11C, show a set of diagrams that illustrate ENNs learn a greedy symbolic algorithm to build binary decision trees (BDTs) according to one or more example embodiments of the present disclosure;

FIGS. 12A-12F, show a set of diagrams that illustrate ENN decision boundaries confer robustness to noise and attacks according to one or more example embodiments of the present disclosure;

FIGS. 13A-13D, show a set of diagrams that illustrate shows that ENNs are robust on the rectangle problem according to one or more example embodiments of the present disclosure;

FIG. 14 shows various biological systems interpreted in the ENN framework according to one or more example embodiments of the present disclosure; and

FIG. 15 shows a system diagram for training a neural network according to one or more example embodiments of the present disclosure;

FIG. 16 illustrates an exemplary machine configured to perform computing operations according to one or more example embodiments of the present disclosure.

### DESCRIPTION

The present disclosure provides a machine learning algorithm to bridge the aforementioned symbolic-connectionist divide using the philosophy of essences. Such algorithms (“essence neural networks” or ENNs) can be more explainable and capable of simulating symbolic reasoning. The integration of symbolism can allow ENNs to be explainable and capable of hierarchical organization, deliberation, symbolic manipulation, and concept generalization. They can also be more modular, sparse, and robust to noise and adversarial attacks. These networks can represent a new interpretation of the complex connections and activities of biological neural networks and how they give rise to perception and reasoning.

The disclosed ENNs can integrate the symbolic Aristotelian theory of essences with the connectionist model of deep neural networks. This approach does not start with a random guess or use incremental improvements in network performance but instead builds the network using the underlying structure (or “essence”) of the learning problem. This allows a human-level explainability of decision-making, the ability to find symbolic and therefore highly generalizable solutions, and greater robustness to input noise and adversarial attacks.

Such an approach is different from the known techniques, which are based on the gradient minimization of the error function and are referred to as gradient descent networks (GDNs). Therefore, the known approaches are not able to utilize the structure of the problem. In contrast, the underlying structure of the present approach can be based on finding an optimal category structure for the problem, rather than seeding with random structure and performing gradient optimization used in the known approaches.

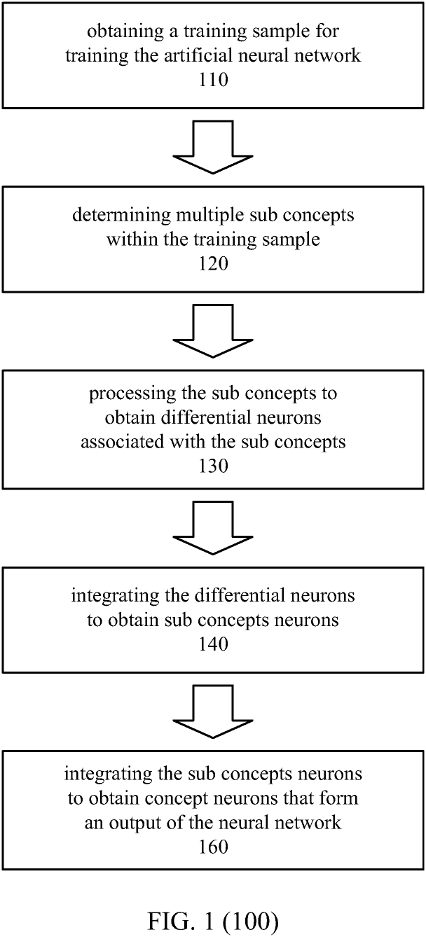

FIG. 1 illustrates a flowchart for a method 100 to train a neural network based on the present approach. The method 100 can include a step 110 of obtaining training samples (dataset) for training the neural network. In an exemplary embodiment, a rectangles dataset can be synthetically generated, with each image being a 28×28 black image with a white rectangular oriented horizontally or vertically. The convex dataset can also be synthetically generated, each image containing a filled convex or non-convex shape. For both the rectangle and convex data sets there can be about 50,000 training images and 10,000 test images. The Modified National Institute of Standards and Technology (MNIST) dataset can be used that includes 70,000 28×28 grayscale images of handwritten digits 0 through 9.

In an exemplary embodiment, training images used can be 28×28 black images with a one-pixel-wide stripe across the full length or height of the image, which means there can be 56 total training images. The diagonal line and box outline datasets can be generated as follows. For each pair of possible heights and widths of non-square rectangles in the image, no more than 50 unique rectangles with randomly placed corners can be generated. This rectangle’s outline can be drawn to make the box outline datasets, and one of its two diagonals can be chosen randomly to make the diagonal line dataset.

The method 100 can include a step 120 of determining multiple sub concepts within the training samples. In an exemplary embodiment, the determining of the sub concepts can be done via unsupervised learning. A hierarchical linkage clustering can be used within each class, choosing a single cutoff value for all concepts’ linkage trees such that the desired total number of sub concepts be obtained. Ward clustering metric can provide good results due to its emphasis on generating compact clusters of comparable size.

The method 100 can include a step 130 of processing the sub concepts to obtain differential neurons associated with the sub concepts. The differential neurons can provide a relative distinction between the sub concepts.

The step 130 of processing the sub concepts can be performed using linear SVMs. The weights and intercepts of the SVMs can be scaled by a multiplier hyperparameter to alter the steepness of the neuron response, and these can become the weights and biases of the inputs to each differential neuron in the first layer.

In an exemplary embodiment, the output of a neuron can be σ(ω·x+b), which is a function of the distance of the incoming signal x from the neuron’s hyperplane w with bias b, with a sigmoid activation function

$$σ \left(x\right) = \frac{1}{1 + {e}^{- x}}$$

saturating the output between non-firing (0) and maximal firing or neurons. It is therefore natural to model neurons as responsible for separating, or distinguishing, concepts.

SVMs (support vector machines), as described herein, are merely an example of the supervised learning techniques that may be used in step 130. A person of ordinary skill in the art would appreciate that other similar techniques can also be used. In an exemplary embodiment, it may be unnecessary to compute differentiae between sub concepts of the same concept.

The method 100 can include a step 140 of integrating the differential neurons to obtain sub concepts neurons. The sub concepts neurons can provide an absolute distinction of the sub concepts. To perform step 140, an initial SVM can be generated between each sub concept and all other concepts using the differentia neuron outputs. To improve running time, this SVM may use as features the differentiae associated with the particular sub concept.

Neurons whose absolute weight values in the SVM are low can be sequentially masked and then the SVM can be recomputed. This sequential pruning can be halted either when the SVM’s margin drops below a certain fraction of the original SVM’s margin or when its misclassification error increased by a certain amount. This can be done for each sub concept, and the differential neurons that are no longer being used by any sub conceptual SVM can be pruned from the network.

The method 100 can include a step 150 of integrating the sub concepts neurons to obtain concept neurons that form an output of the neural network. To connect the sub conceptual neurons with the output conceptual neurons, either an SVM can be first computed for each conceptual class separating it from all other classes or each sub concept can be connected to its own concepts. The weights and intercepts of the SVM can be scaled by a multiplier to become the weights and biases for each sub conceptual neuron which can be followed by a sigmoid activation function.

In an exemplary embodiment, to improve network accuracy and assign more meaningful output probabilities, the weights can be refined using a stochastic gradient descent approach for this final layer, using a categorical cross-entropy loss function. This gradient descent can also be used to find the best hyperparameter value for the sub concept SVM multiplier. At the end of the ENN a softmax layer can be placed to turn the concept neuron outputs into probabilities or left as a sigmoid output.

There are several hyperparameters found in method 100 that can be user-defined. The number of sub concepts can define the size of the second layer of neurons. Each SVM may require a cost to set the softness of the margin and a multiplier to scale the response. For the pruning, there can both be a tolerated margin fraction and misclassification tolerance used to determine when to halt. With gradient descent in the final layer the multiplier for the sub conceptual layer can also be found, with the hyperparameter here serving as a maximum value.

To find an optimal set of hyperparameters, a grid search can be done using 10-fold cross validation. To speed up the search process this can be done on a restricted set of training data to narrow down several hyperparameters. For the final results, several ENNs can be trained on each problem with all the same hyperparameters except for a variable number of sub concepts and a variable pruning toleration margin to vary the size of the network.

Based on the above steps (110-150), the method 100 can optimally split the input space into distinct convex regions using differentiating feature hyperplanes, and the neural network can be trained to judge all inputs according to the distinguishing features and then to assign the input to a unique sub concept based on the unique combination of features that it satisfies. The sub concept can then be assigned to the given output, with multiple sub concepts possibly mapping to the same output. A linear separability of disjoint convex sets is useful because artificial neurons can be modeled mathematically as hyperplanes.

The disclosed ENNs, in contrast to known Voronoi neural networks (VNNs), can learn from aggregate concepts and sub concepts. This is a fundamentally different approach that focuses on concepts instead of exemplars and therefore makes smooth, natural distinctions instead of memorizing every past experience (i.e. nearest neighbors) task.

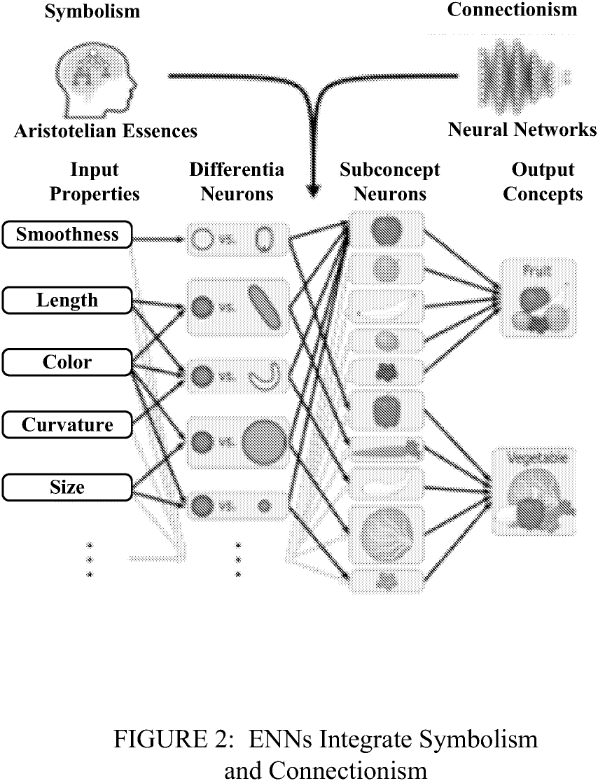

FIG. 2 shows the disclosed model being applied to fruits and vegetables according to an exemplary embodiment of the present disclosure. The ENN schematic classifies a piece of produce as either a fruit or vegetable. The input features feed into the differentia neurons, each of which distinguishes a particular fruit from a particular vegetable (only apple-distinguishing differentiae are drawn). Each differentia neuron feeds into the two sub concept neurons of the fruit and vegetable that it has distinguished. These sub concept neurons each feed into the desired output concept.

Other such non-limiting examples can include recognizing animals with life-cycle morphological changes, to read letters in different fonts or cases, etc. The next section describes various properties of ENNs in detail and compares the disclosed ENNs and known techniques (e.g. GDNs) for the same input signals.

### Scalability

ENNs can scale to problems with larger datasets and with many more features without having to grow exponentially in the number of neurons or in training time. Table 1 below illustrates a scale comparison between the disclosed ENNs and known GDNs. Table 1 provides the results of training ENNs and a GDN of the same size on several datasets. Shown are the sizes of each training set, the sizes of the learned ENN, the training times, and the performance results on a test set for the ENN and a trained GDN of the same size.

| Problem | Training Samples | Output Classes | Input size | Conv. Layers | Layer 1 neurons | Layer 2 neurons | GDN time (min) | ENN time (min) | GDN error | ENN error |
|---|---|---|---|---|---|---|---|---|---|---|
| Perception tasks | | | | | | | | | | |
| Rectangles | 50000 | 2 | 28×28 | - | 201 | 56 | 4.7 | 13.4 | 0.02% | 0.22% |
| Convex shapes | 50000 | 2 | 28×28 | - | 311 | 80 | 17.4 | 46.5 | 7.66% | 6.93% |
| MNIST | 60000 | 10 | 28×28 | - | 394 | 60 | 39.8 | 22.5 | 1.62% | 2.73% |
| MNIST | 60000 | 10 | 28×28 | 6 (5×5) 16 (5×5) | 127 | 84 | 41.5 | 61.0 | 1.03% | 2.35% |
| MNIST | 60000 | 10 | 28×28 | 12 (3×3) 64 (3×3) | 3167 | 84 | 49.8 | 123.5 | 0.93% | 0.86% |
| Symbols manipulation tasks | | | | | | | | | | |
| Logic | 64 | 2 | 18 | - | 4 | 4 | 0.06 | 0.01 | 0% | 0% |
| Orientation lines | 36 | 2 | 28×28 | - | 78.4 | 56 | 0.20 | 0.05 | 7.30% | 0% |
| Orientation diagonal lines | | | | | | | | | 31.67% | 0% |
| Orientation box outlines | | | | | | | | | 32.75% | 0% |
| Traveling salesman problem | 90 | 10 | 55 | - | 405 | 90 | 1.15 | 0.07 | 2.04 units | 0.00 units |
| Binary decision boxes | 20 | 10 | 1024 | - | 180 | 20 | 0.05 | 0.02 | 0.794 modes | -0.001 modes |

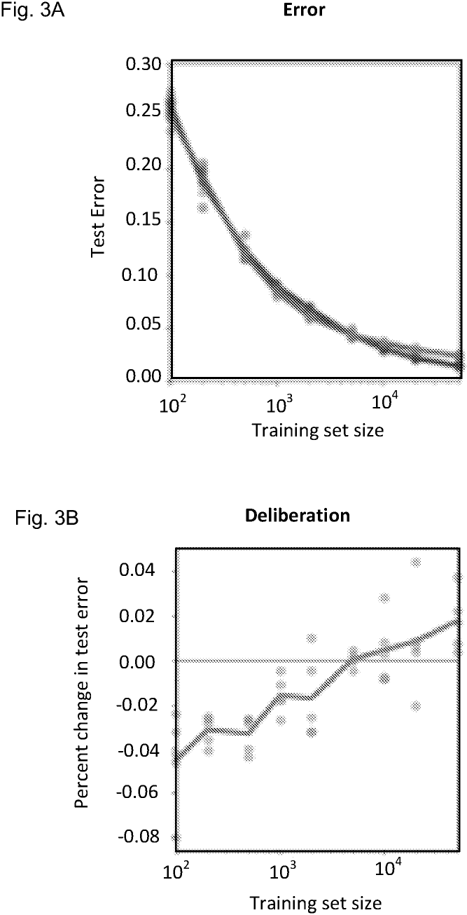

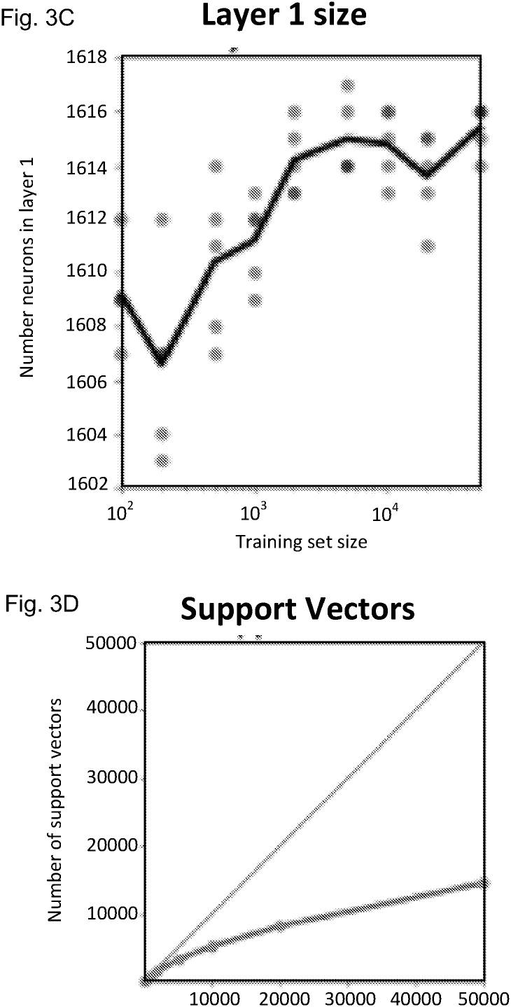

FIG. 3 provides a set of diagrams that show that ENNs are scalable. ENNs and GDNs trained on random subsamples of a MNIST training set, tested on the full test set are shown. Points in the figure indicate individual networks, and the lines connect the average at each training set size (or the geometric average in (E)). Panel (A) shows the test error for GDNs and ENNs with different training set sizes. Panel (B) shows the ENNs trained on smaller training sets typically improved with added deliberation (dENNs). Panel (C) shows the networks each had 60 sub concept neurons, and without pruning differentia neurons from the first layer its sizes were approximately constant. Panel (D) shows the number of training images that serve as support vectors grows sub linearly with the training set size. Panel (E) shows the training time for ENNs and GDNs was comparable across various training set sizes, depending on ENN and GDN hyperparameter choices.

In an exemplary embodiment, the reported training times can be the measured wall times-starting once the training data is loaded and ending with the end of storing all of the network’s parameters—on a computing cluster on a single non-GPU node without parallelization for a fair comparison against ENNs.

In an exemplary embodiment, error rates can be from the test sets, which can be held out from training and hyperparameter optimization. In order to assess how the size of the training set affected performance, ENNs and GDNs can be trained on random subsamples of MNIST, each subsample with the same number of images from each class. For each subsample size this can be repeated five times. The same ENN hyperparameters can be used, with 60 sub concepts and without any pruning to maintain a consistent network size, as shown in panel (C) of FIG. 3. For each ENN and subsample a GDN can be generated, using 5-fold cross-validation to find the optimal batch size and training epochs for each. During ENN training, the images that served as support vectors can be tallied and reported.

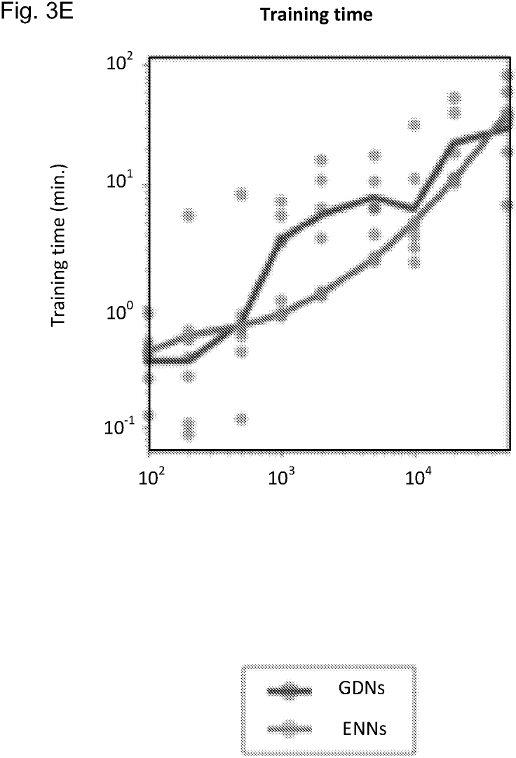

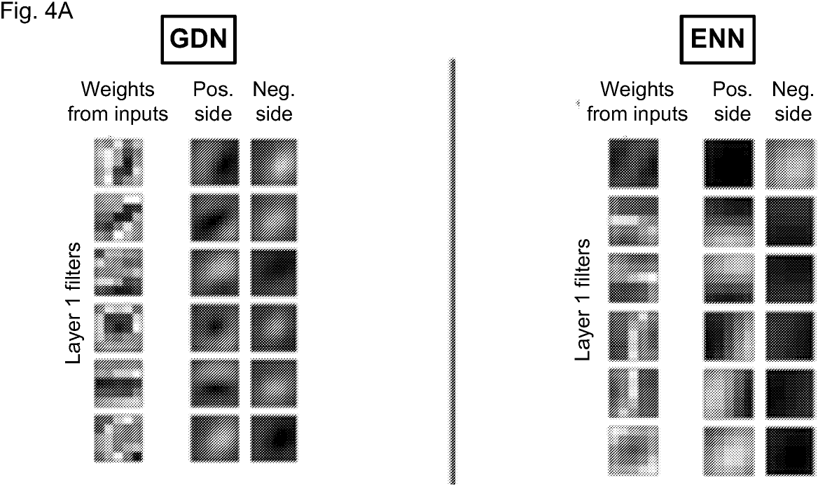

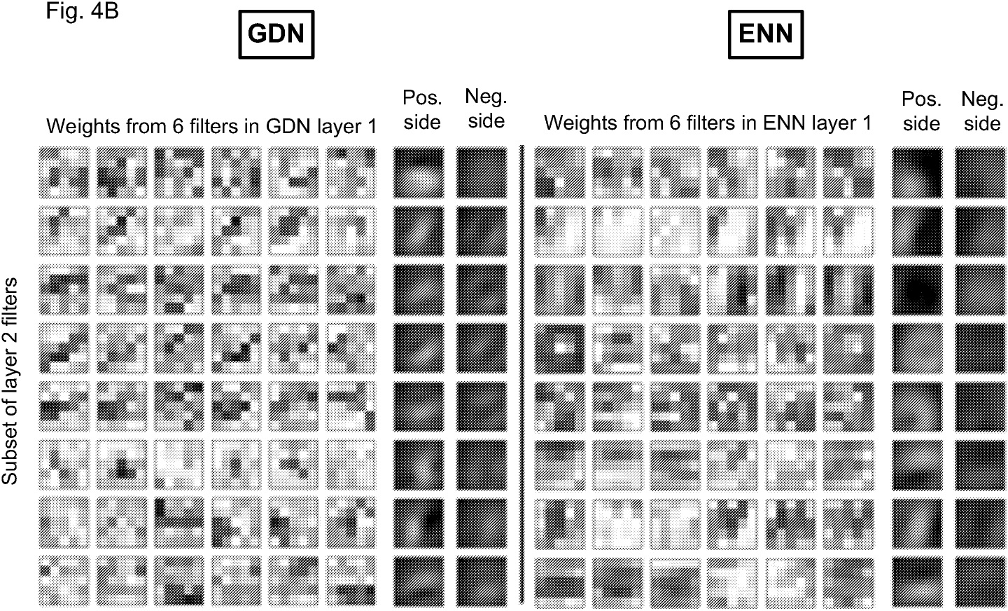

FIG. 4 illustrates that convolutional ENNs (cENNs) can learn more explainable features. A convolutional ENN and GDN were trained on the MNIST dataset. They contained 6 5×5 filters in the first layer and 16 5×5 filters in the second layer. Each filter’s weights are shown (red pixels are positive, blue are negative). Also shown are the weighted averages of windows that fall on the positive and negative sides of the filter’s hyperplane (panel A) The convolutional filters from the first layer. (panel B) Eight of the filters from the second layer. In both layers, but especially the second layer, the ENN seems to have more regular and “cleaner” filter weights, and the corresponding feature visualizations appear more discernible, especially those lying on the positive side of the filter. Sub image windows can be clustered to find local feature sub concepts, and then SVMs can be computed to generate the cENN’s convolutional filters. At the end of the convolutional layers a regular ENN can be trained to produce the final output.

In an exemplary embodiment, training of cENNs can begin by obtaining sub images from the training set randomly sampled equally from each class and uniformly within each image. k-means clustering, or other similar techniques, can be used to divide up the sub images into feature sub concepts, with k corresponding to the number of convolutional filters. Each cluster can be collapsed into its average, and one-versus-all SVMs can be computed for each, which generate the convolutional filters.

The outputs of this layer can be passed through a max-pooling layer. Another set of convolutional filters and a max-pooling layer can be performed on the outputs of the first max-pooled convolutional layer. The outputs of the second max-pooling layer can then be fed into the ENN learning algorithm.

In an exemplary embodiment, for the convolutional layers SVM multipliers of 2, stride rate of 1×1 pixel, and max-pooling with non-overlapping 2×2 pixel boxes can be used. The MNIST input images can be padded out to be 32×32 pixels consistent with LeNet-5. The smaller of the two cENNs in Table 1 can be designed to be of similar dimensions to LeNet-5—the tolerated margin fraction adjusted to achieve this-and its learned filters, as shown in FIG. 4. The larger cENN can be designed without any hyperparameter search, instead using the same parameters as ENNs before and without any differentia neuron pruning.

The filters can be visualized both by plotting their weights and by computing the weighted average of all windows in the test set which lie on either side of the filter’s hyperplane. Taking the filter neuron’s output yi for each window, the weight applied to each can be |yᵢ - 0.5|. For the second set of convolutional filters, the same can be done, but taking the full receptive field from the original image that pertained to each filter.

In an exemplary embodiment, ENNs can also be amenable to post-training adaptation. Two cognitive systems described by dual-process theory can be simulated - System 1 making rapid, intuitive decisions, and System 2 performing slow, deliberative reasoning. Feedforward neural networks can be analogous to System 1, and System 2 can be mimicked by allowing deliberative ENNs (dENNs) to dynamically modify the bias factors of their sub concept neurons whenever they had low classification certainty. This can improve classification accuracy, especially when training with smaller amounts of data or on symbolic problems.

Their dynamic, post-training deliberation can be implemented in multiple ways. One such way includes providing a test sample to the network, to see if there are two output probabilities that are within a factor of given factor (which can be 2 in certain cases except for the TSP, where it was 10). In such a case, deliberation can be allowed to occur on that sample.

The network then can uniformly increase or decrease the bias values of its sub conceptual neurons in order to attempt to find a result where the output probabilities are well separated. It can choose to increase the bias factor if none of the sub conceptual neurons are firing over 0.5 and decrease otherwise. The biases can be changed uniformly because computing the SVMs scales them all so that the weighted distance to the hyperplane is the same.

### Explainability

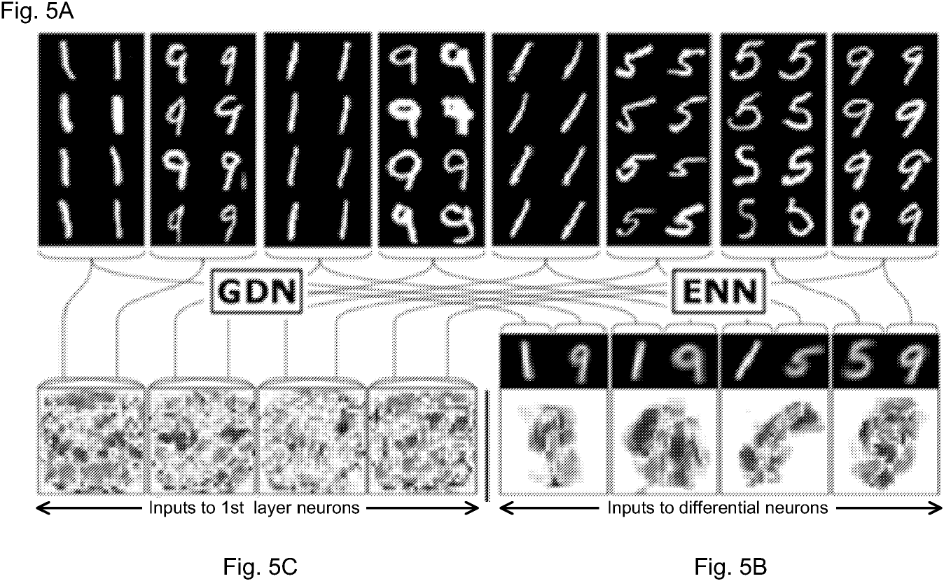

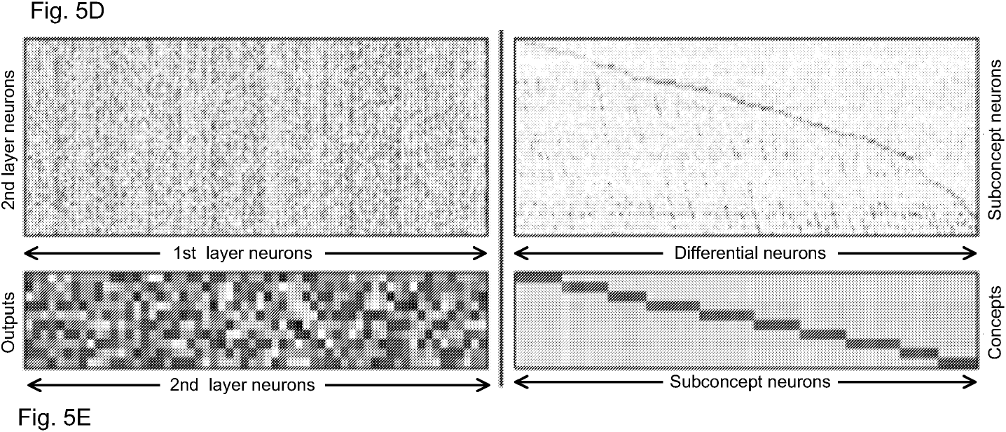

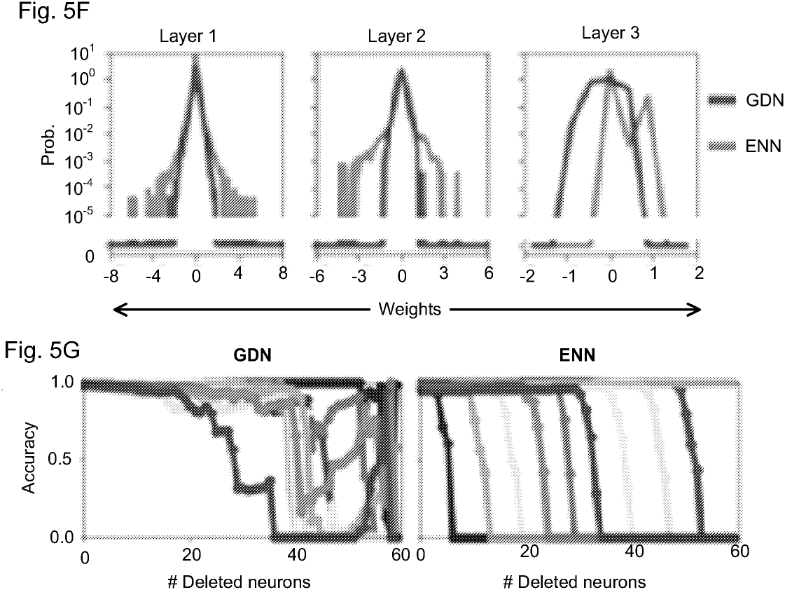

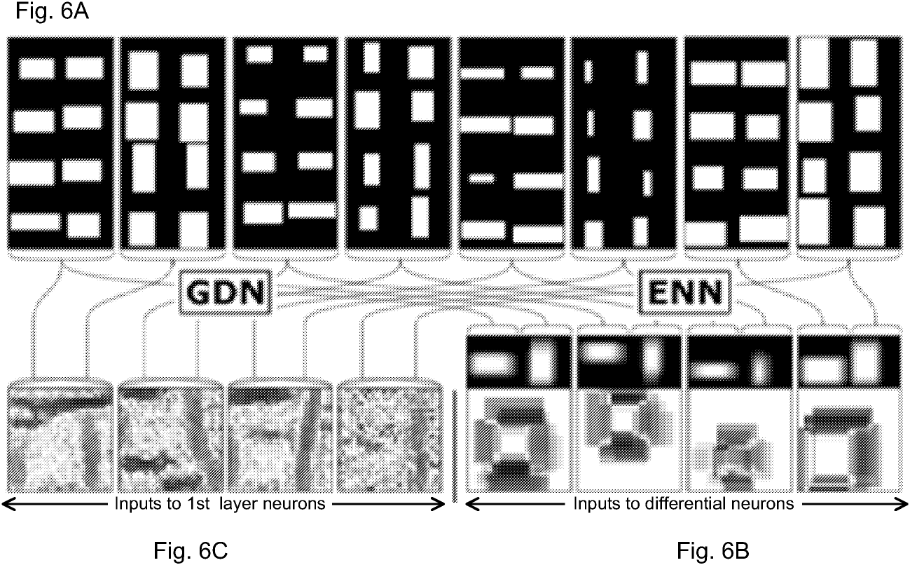

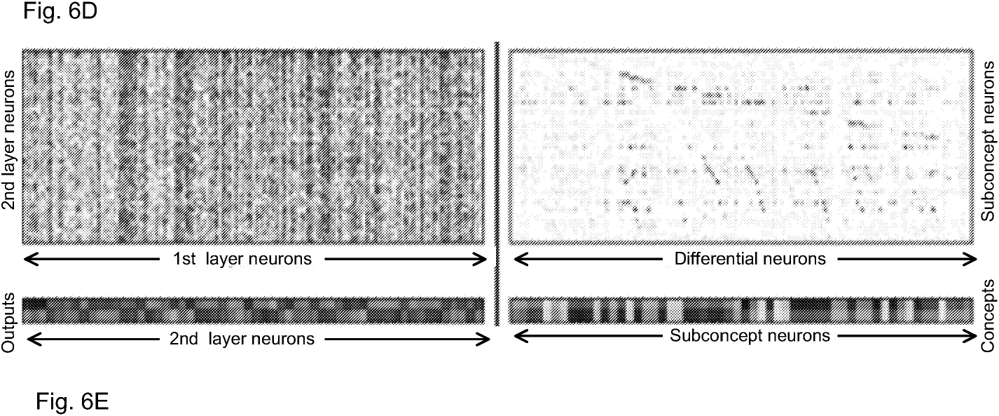

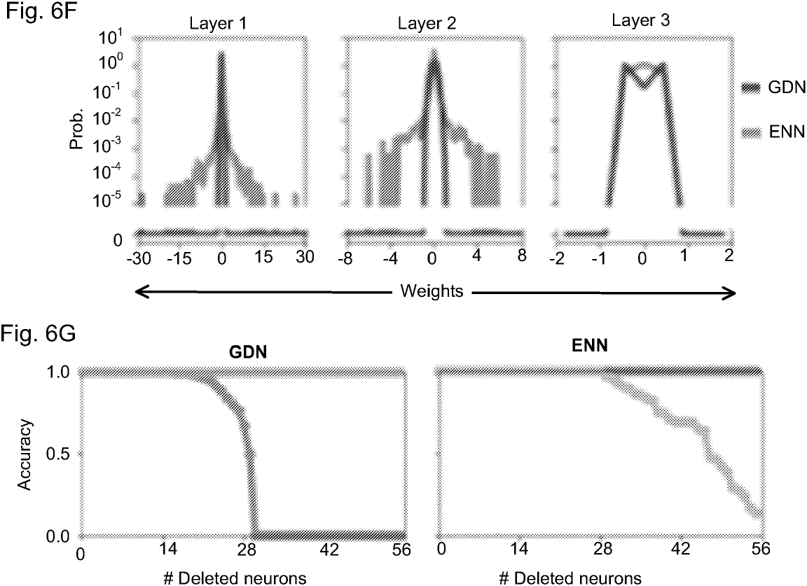

FIG. 5 and FIGS. 6 demonstrate that every neuron of an ENN can be designed for the purpose of separating opposing concepts (i.e. ENN weights can be explainable sparse, and modular), as described in detail as follows.

In FIG. 5, (panel A) shows example MNIST training images. (Panel B) shows ENN learning firsts clusters images within each concept into sub concepts. Several sub concept averages are shown, with lines connecting from examples in (panel A). (Panel C) shows first-layer neurons, with incoming synaptic weights from each pixel of the input (red are positive weights, blue are negative). The ENN neurons shown are those that distinguish the pairs of sub concepts in (panel B). The GDN neurons shown are those that happen to maximally separate the ENN’s sub concepts. (Panel D) shows the connectivity matrix between the first and second layers of neurons. (Panel E) shows the connectivity matrix between the second and third layers of neurons. (Panel F) shows the distribution of synaptic weights from (panels C-E), showing the fat tail in the ENN distributions. (Panel G) shows the results of sequentially deleting neurons from the second layer and the accuracy of the network in classifying each of the 10 classes of digits, colored separately. Each of these are explained in detail below in comparison to corresponding items from FIG. 6.

In FIG. 6, (panel A) shows example rectangle training images. (Panel B) shows ENN learning firsts clusters images within each concept into sub concepts. Several sub concept averages are shown, with lines connecting from examples in (panel A). (Panel C) shows first-layer neurons, with incoming synaptic weights from each pixel of the input (red are positive weights, blue are negative). The ENN neurons shown are those that distinguish the pairs of sub concepts in (panel B). The GDN neurons shown are those that happen to maximally separate the ENN’s sub concepts. (Panel D) shows the connectivity matrix between the first and second layers of neurons. (Panel E) shows the connectivity matrix between the second and third layers of neurons. (Panel F) shows the distribution of synaptic weights from (panels C-E), showing the fat tail in the ENN distributions. (Panel G) shows the results of sequentially deleting neurons from the second layer and the accuracy of the network in classifying each of the two classes of rectangles, colored separately. Each of these are explained in detail below in comparison to corresponding items from FIG. 5.

FIG. 5, panel A shows exemplary MNIST training images of handwritten digits. FIG. 6, panel A shows exemplary images of horizontally or vertically oriented rectangles. FIG. 5, panel B and FIG. 6, panel B illustrate that ENN differentia neurons can positively weight pixels more associated with a particular sub concept and negatively weight those of a different sub concept. However, GDNs show little to no intelligible structure in the weights of synapses between image pixels and first-layer neurons, as illustrated in FIG. 5, panel C and FIG. 6, panel C.

FIG. 5, panel D and FIG. 6, panel D show that connections between deeper layers of neurons in GDNs are typically even less decipherable, with no learned sparsity or modularity. When ENNs learn the weights between differentia and sub concept neurons, each sub concept can be allowed to make use of all available differentiae, yet we observed that they each rely on only a handful of important differentiae, with relative sparsity of strongly weighted connections, as shown in FIG. 5, panel E and FIG. 6, panel E.

FIG. 5, panel F and FIG. 6, panel F illustrate distributions of weights that show a corresponding fat tail in ENNs but not GDNs. The sparsity in the last two ENN layers can suggest a higher degree of modularity, which, though not explicitly enforced during training, can be the expected consequence of the ENN model. This functional modularity can be apparent when ENN sub conceptual neurons are progressively deleted to see a sequential loss of class-specific accuracy, as shown in FIG. 5, panel G and FIG. 6, panel G. This is reminiscent of the sequential loss of function seen in progressive neurological disorders with focal lesions, such as multiple sclerosis and vascular dementia.

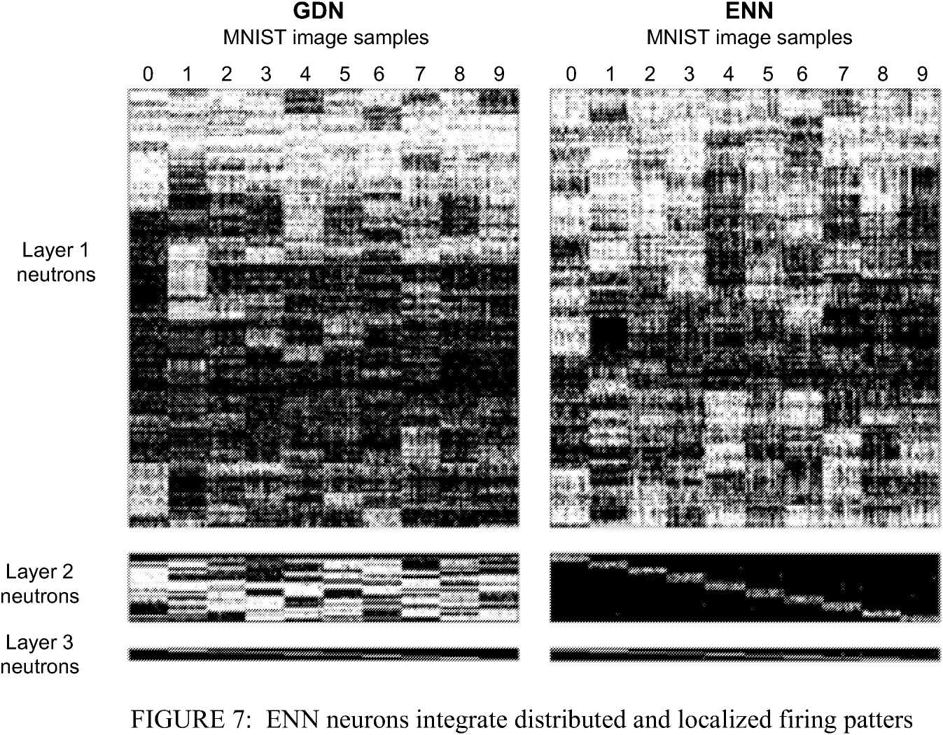

FIG. 7 illustrates that ENNs can integrate the localist and distributed theories of brain function in an interpretable manner. The firing patterns of all neurons in a GDN and ENN, trained on the MNIST dataset, when exposed to 350 random test images of different digits are shown. Neuron outputs are shown in grayscale, with maximal firing in white and no firing in black. The GDN and ENN both have distributed firing patterns, but ENNs are able to utilize more sparse, localized firing in the second layer. Neurons are arranged by cluster analysis on the firing patterns across these 350 test images. The networks used sigmoid output neurons to better mimic biological neural networks.

While a distributed neural circuit encodes information in diffuse firing patterns across many non-selective neurons, a localized network has neurons highly selective for specific stimuli or processes (e.g. “grandmother cells”). In ENNs, differentiae neurons can have a distributed firing pattern, while the sub concept and concept neurons can fire much more sparsely and selectively. There is increasing evidence that this hierarchical separation of distributed and localized firing patterns is how parts of animal nervous systems are organized.

### Generalize Concepts Using Symbolic Manipulation

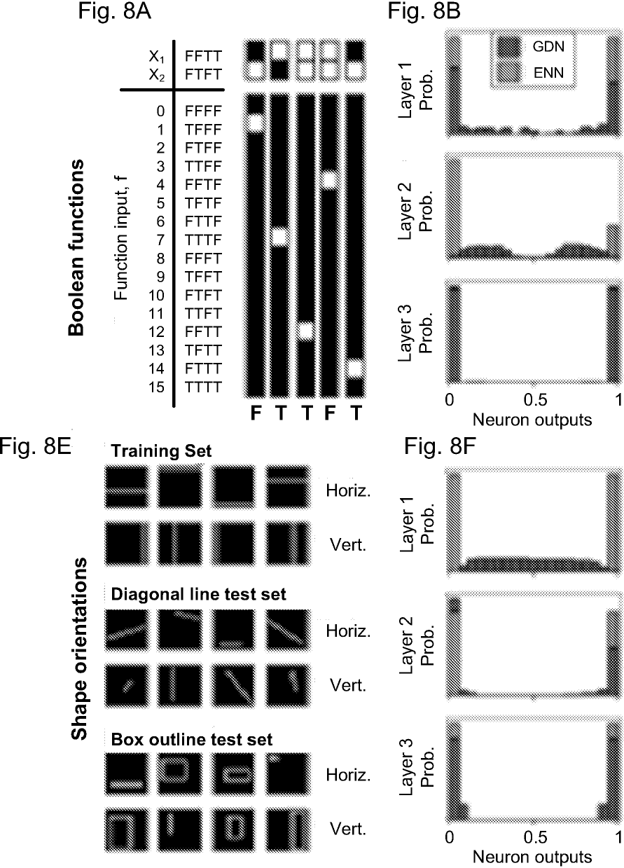

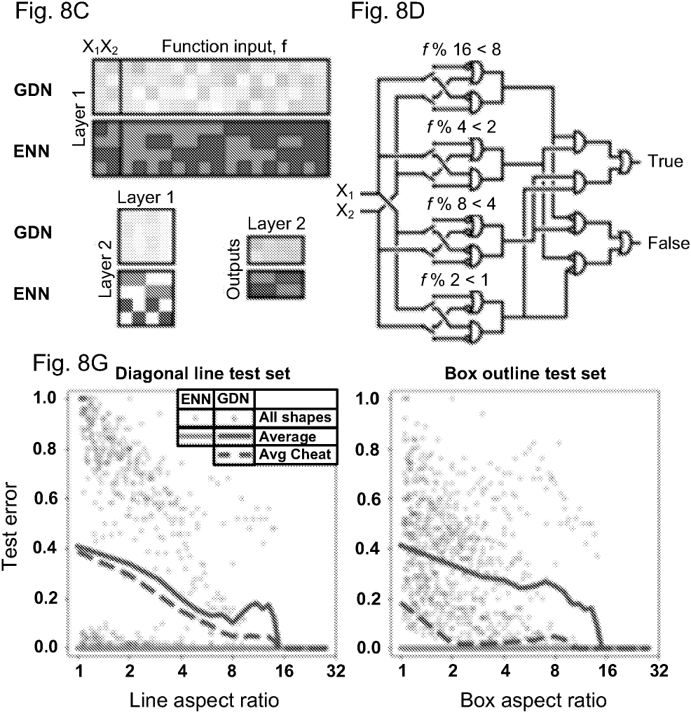

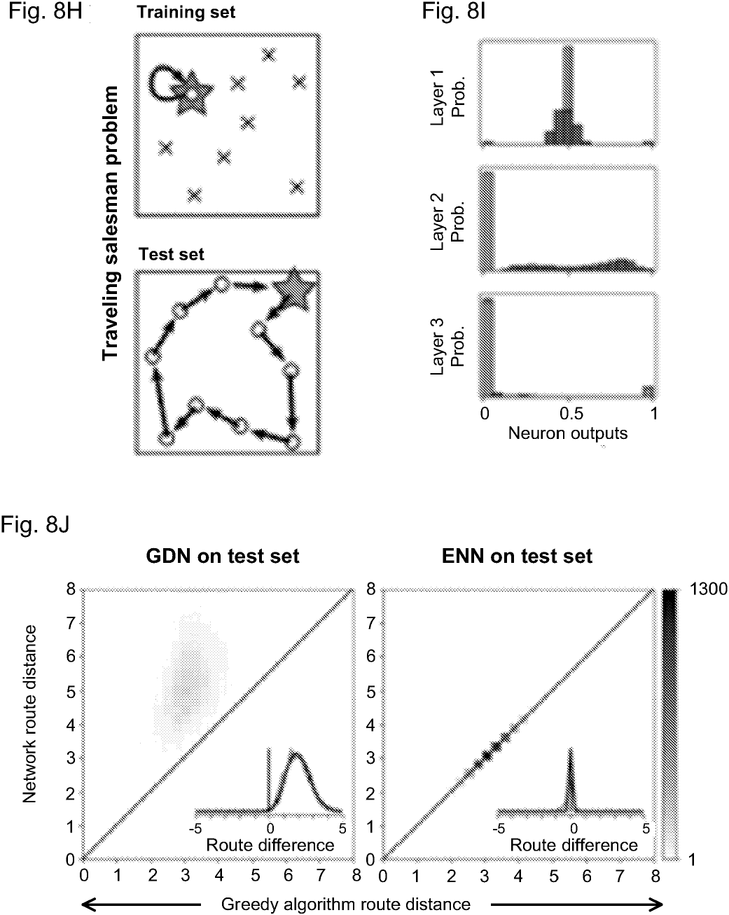

FIG. 8 illustrates that ENNs can implement symbolic manipulation and generalize rules. (A) shows the truth table for all 16 functions, with examples of 5 entries’ encoding. (Panel B) shows the distributions of neuron outputs across all inputs. (Panel C) shows the connectivity matrices of GDN and ENN layers (red are positive weights, blue are negative). (Panel D) shows the ENN-derived logic circuit. (Panels E-G) show orientation problem results. (Panel E) shows the training set contains images with a full-image line, while the test sets include either diagonal lines or box outlines. (Panel F) shows the distributions of neuron outputs on the orientation training set. (Panel G) shows that while ENNs generalize perfectly to the diagonal and box datasets, GDNs cannot, especially for low aspect ratio diagonals and box-es. Each point represents a particular diagonal or box with its error rate over translations. (Panels H-J) show TSP results. (Panel H) shows a map consists of 10 cities, beginning at the red star, and finding the best route of unvisited cities (yellow dots) to visit. Black x’s are previously visited cities. (Panel I) shows the distributions of neuron outputs on the TSP training set. (Panel J) shows a comparison of the distances of routes built by GDNs and ENNs to the nearest-neighbor algorithm. Inset is the distribution of differences in routes (black lines), including results from expanding the training set (gray lines). Each of these as described in detail as follows.

FIG. 8, panel A shows a GDN and an explicitly symbolic ENN that may learn all 16 two-input Boolean functions (e.g. AND, OR, NAND, XOR, etc.) by training on all 64 entries of the truth table. Each training sample contained 18 values, the first two representing the function’s binary inputs and the remaining 16 serving as a one-hot encoding of the Boolean function itself. Both GDNs and ENNs were successful at achieving perfect accuracy on this dataset, as shown in Table 1. In an exemplary embodiment, the function input features can be scaled by a factor of 2 to get consistent clustering into ENN sub concepts, so True inputs can be encoded as 1 and False entries can be encoded as -1.

The ENNs can learn large-magnitude weights so that each neuron only fires at 0 or 1, as shown in FIG. 8, panel B. It was found that the GDN synaptic weights lacked explainability while ENN weights were very regular, as shown in FIG. 8, panel C. This can allow a mapping of the ENN directly to a logic circuit, as shown in FIG. 8, panel D, demonstrating the capacity for ENNs to implement symbolic manipulation. In an exemplary embodiment, the logic circuit, as shown in FIG. 8, panel D, can involve 4 pairs of switches that depend on the function being called. When the inequality indicated is satisfied, both switches in the pair can move upward, and otherwise the switch can move downward.

Symbolic reasoning can allow learning simple rules from limited experience and apply them to more complex problems. The ability to extrapolate from one distribution of inputs to a different one without any additional training (blind generalization). To test this, a GDN and a symbolic ENN can be trained on a set of images that contained a one-pixel white stripe oriented horizontally or vertically, for 56 total 28×28 images, as shown in FIG. 8, panel E.

FIG. 8, panel F shows that the ENN had symbolic firing and therefore was able to be translated into pseudocode. Moreover, unlike the GDN, the ENN could correctly describe the orientation of shorter line segments, diagonal line segments, and rectangular box outlines, as shown in FIG. 8, panel G.

FIG. 8, panel H shows a training set and a test set for the traveling salesman problem (TSP), a classic NP-hard problem. The training set can include, for example, 90 10-city maps, each starting from a different city and with only one unvisited city remaining at zero distance from the current one.

In an exemplary embodiment, the TSP can feature a salesman trying to find the shortest possible route that takes him through all cities on a map and return home. Both the training and test sets can include samples with 55 features, 45 corresponding to the upper half of the inter-city distance matrix for a 10-city map, and the remaining 10 serving as a one-hot encoding of the current city, scaled up by 10. The cities can be located on a map on the unit square. Cities that have already been visited can be denoted in the distance matrix as being a distance of 10 from all other cities. The training set can include 90 samples corresponding to the maps with only on unvisited city. In order to teach a generalizable rule, the correct city to visit next can be located a distance of 0 from the current city.

In an exemplary embodiment, ENN training can be allowed on each sub concept to use as inputs its associated differentiae, and the initial concept layer can use connections of weight 10 between sub concepts and their specific concept neurons which had bias -5. The output neurons can use a sigmoid activation function. After training each network can be asked to find a route for the test set maps. The distance matrix can be given to the networks, which picked the next city to visit. The distance matrix can then be altered by switching the indices of the new city with the current city (i.e. the first index) and setting all distances from the previous city as 10. The network outputs corresponding to cities already visited can be masked to prevent the possibility of endless loops.

In an exemplary embodiment, the test set can include 5000 maps with the 10 cities all placed randomly. To serve as a reference for a greedy algorithm, each map can be put through the greedy nearest-neighbor algorithm (i.e. choose for the next city the closest unvisited city). The test error reported for the TSP can be the average difference in the route length found by the neural network compared to the nearest-neighbor algorithm.

FIG. 8, panel I shows that the trained ENN was symbolical and could be translated into pseudocode. In order to break ties, the ENN had to be able to deliberate (dENN). The GDN, despite perfect training accuracy, did not generalize to the full-map test set, while the ENN performed almost identically to the greedy nearest-neighbor algorithm, as shown in FIG. 8, panel J. Cheating to find a good network size again showed no improvement. Moving a random set of 4000 of the 5000 test problems into the training set showed only very modest improvement for the GDNs in non-blind generalization (gray lines in FIG. 8, panel J).

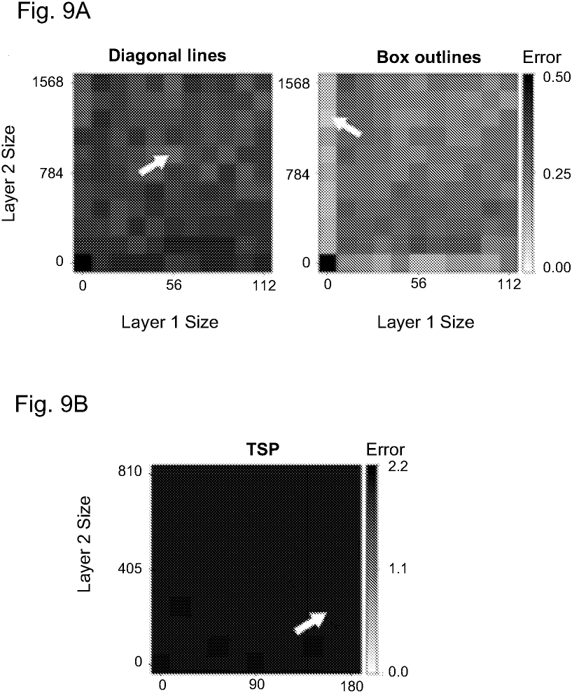

FIG. 9 shows that GDNs of different network sizes cannot generalize. GDNs were trained on the training sets of the orientation problem and the TSP and hyperparameters were optimized to give the best performance on the generalized test sets. Shown here are the results of a grid search over network sizes. Arrows indicate the net-work size that produce the best possible GDNs. (Panel A) shows heatmaps of the average test error of orientation-trained GDNs on the diagonal line and box outline test set sets. For each trained 10 GDNs, (Panel B) shows a heatmap of the fraction of routes found by TSP-trained GDNs longer than the greedy algorithm’s route for different GDN sizes, aver-aged over 5 trained GDNs.

GDN could not be generalized perfectly by changing its size, running GD many times, and choosing the network with best test set performance. GD could not train a network that perfectly generalized to the diagonal line and box outline datasets when the noise levels were as low as 1% and 3%, respectively.

In an exemplary embodiment, to demonstrate the rarity of finding a generalizable solution with GDNs, the weights of the generalizing ENN can be perturbed by a small amount, and then be trained as a GDN. The perturbation can include adding a normally distributed value to all weights and biases, with the standard deviation being a given fraction of the mean weight magnitude for each layer separately.

In an exemplary embodiment, lesions can be performed in the second layer (sub conceptual neurons in ENNs). Neurons can be deleted sequentially, and test accuracy can be calculated individually for each class. The sequence of neuron deletions can be decided by using hierarchical linkage clustering on their outputs on the test set, with the assumption that neurons with similar firing patterns are physically located more closely together.

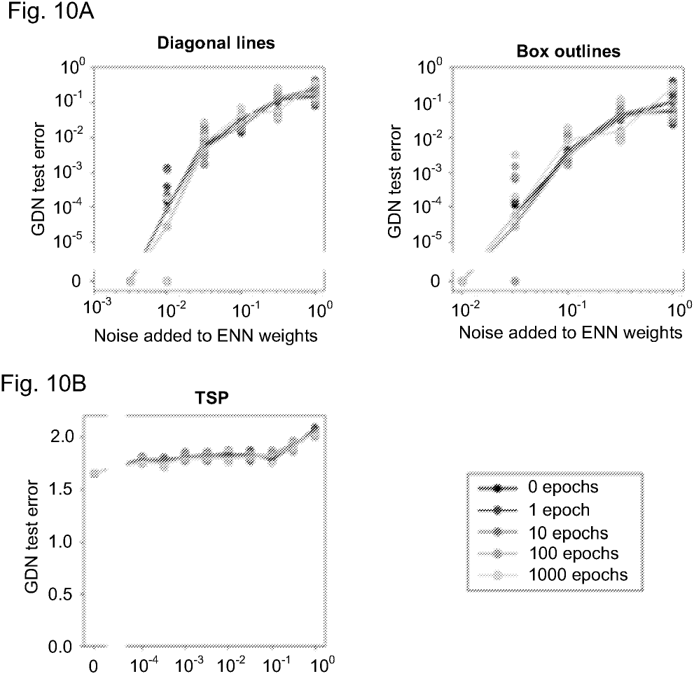

FIGS. 10 shows the improbability of GDNs finding generalizing networks. The GDN pre-training weights were seeded with ENN weights that had various amounts of noise added to them. The results of these GDNs trained for different numbers of epochs are shown. Dots indicate all 5 repeats for each noise level and number. (Panel A) shows the test error of orientation-trained GDNs on the diagonal line and box outline test sets. (Panel B) shows the fraction of routes found by the TSP-trained GDN longer than the greedy nearest-neighbor algorithm’s route.

GDNs performed worse with noise of 0.01%, demonstrating the virtual impossibility of GDNs learning a generalizable rule to map short routes. GDN pre-training weights can be seeded with ENN weights that have various amounts of noise added to them. The results of these GDNs can be trained for different numbers of epochs are shown. Dots indicate all 5 repeats for each noise level and number. FIGS. 10, panel A shows the test error of orientation-trained GDNs on the diagonal line and box outline test sets. FIG. 10, panel B shows the fraction of routes found by the TSP-trained GDN longer than the greedy nearest-neighbor algorithm’s route.

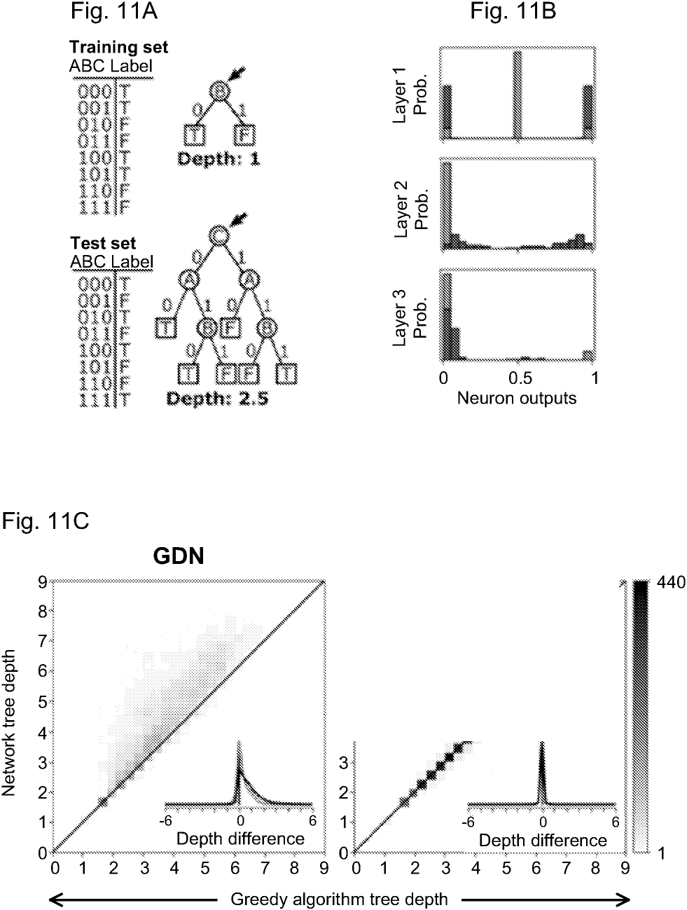

FIG. 11 shows that ENNs can learn a greedy symbolic algorithm to build EDTs. (Panel A) shows simplified schematic of the BDT problem for 3-input truth tables (networks were trained on 10-input tables). Networks were trained on truth tables that only require a one-node BDT and were tested on truth tables requiring much deeper BDTs. (Panel B) shows the ENN was able to learn neurons that fire symbolically while the GDN did not. (Panel C) shows a heatmap for all test-set truth tables comparing the depth of BDTs generated by the greedy CART algorithm or either the GDN or ENN. Inset shows the distribution of differences in the tree depths found, with the gray lines showing the results when the training set was expanded (behind the black line for the ENN).

At each branch point of the tree the networks were asked to choose which feature to split. Training included only the 20 samples of 10-feature truth tables for which the optimal BDT contained a single branch node, while the test set included truth tables with deeper optimal BDTs, as shown in FIG. 11, panel A. Similar results were found as for the TSP, with ENNs performing similarly to the popular greedy CART algorithm, as shown in FIG. 11, panel B and 11, panel C. Therefore, the disclosed ENNs provide a neural network capable of blind generalization and learning to solve a simple problem in a way that naturally becomes a greedy algorithm for more complex situations.

The BDT problem is to find a BDT of minimum depth (i.e. cost) that fully reproduces a truth table. The depth of the tree can be defined as the average depth necessary to classify each entry of the truth table. Both the training and test sets can include samples with 1024 features corresponding to the label associated with each value in the 10-input truth table, encoded as zeros and ones. The training set can include 20 samples corresponding to all possible BDTs with only a single branch node.

In an exemplary embodiment, after training, each network can be asked to build full trees on the test set. This can be done by feeding the truth table to the network and taking its output as the first branch node. Going down each of the branches in turn, if all entries on the branch are labelled the same a leaf can be placed at the end with the corresponding label. If more branch nodes are necessary, the truth table can be reformed by taking the half corresponding to its side of the split and copying onto the other half, such that the already split feature is no longer needed to be split. This new truth table can be put through the network again with masking of the output choices that had already been split in order to prevent an infinite tree. This can be done until all branches have terminated in leaves.

In an exemplary embodiment, the test set can include 5000 truth tables corresponding to trees of much greater depth. For each test sample, a random BDT can be generated by allowing each node to branch with probability 0.7 and not allowing branches beyond a depth of 7. The BDT’s truth table can be found and used as the test sample. To serve as a reference for a greedy algorithm, each tree was put through the CART algorithm with Gini impurity as the splitting criterion, using scikit-learn’s Decision Tree Classifier. The test error reported can be the average difference in the tree depth found by neural network compared to the greedy CART algorithm.

In an exemplary embodiment, for the orientation problem and the TSP, GDNs of varying layer widths can be trained, performing a grid search by scaling from 0 to twice the width of each ENN layer. 10 GDNs can be generated for the orientation problem and 5 for the TSP. Then an architecture can be chosen with the best performance on the test sets as this optimally generalizing GDN. The symbolic nature of ENNs can allow them to be translated directly into computer code. This can be demonstrated by translating into pseudocode.

### Robust to Input Noise and Adversarial Attacks

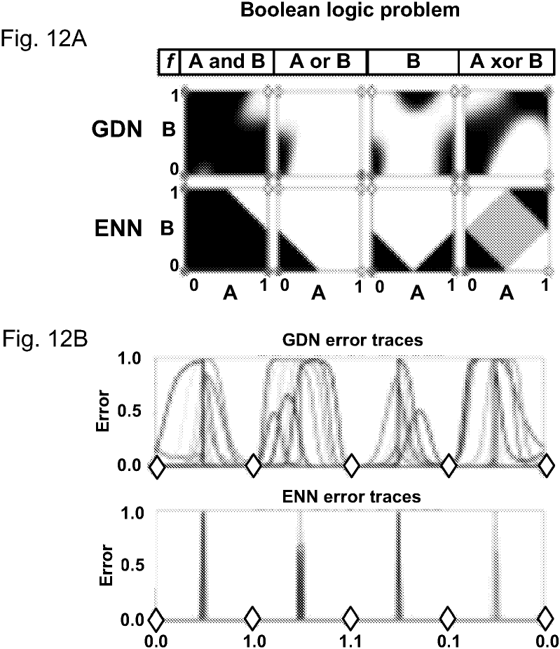

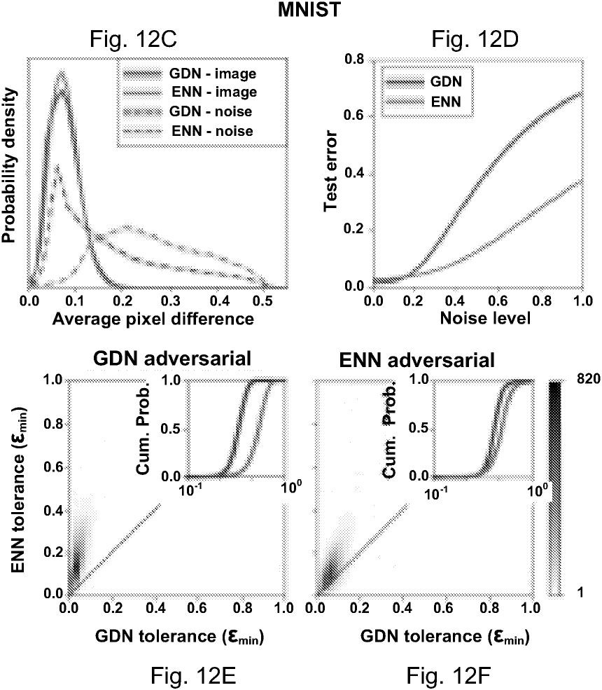

FIG. 12 shows ENN decision boundaries confer robustness to noise and attacks visualizing the decision boundaries learned by the GDN and ENN networks from the Boolean logic problem for various Boolean functions. ENNs have more intuitive decision boundaries spaced evenly between samples, which is the result of using SVMs in ENN learning to space decision boundaries well.

In FIG. 12, (panel A) shows GDN and ENN trained on all 16 Boolean logic functions, with 4 shown here. A and B are function inputs, and in grayscale is the True output probability. Diamonds indicate training samples, with True outputs in light yellow and False in dark yellow False. (Panel B) shows the error between the network output and the closest corner while tracing around the unit squares from (panel A), each of the 16 Boolean functions shown in different colors. (Panels C-F) show a GDN and ENN trained on MNIST, measured on the test set. (Panel C) shows the probability distributions of the average pixel difference between images and a decision boundary, found by interpolating toward either another test images or white noise (with interdecile range shaded). (Panel D) shows the network classification error as Gaussian noise is added to images (with interdecile range shaded). (Panels E-F) show the adversarial attacks were generated against both the GDN and ENN for all test images, with the minimum tolerated eₘᵢₙ multiplicative factors shown in these two heatmaps. Inset is the misclassification error at different eₘᵢₙ.

To measure the separation between data samples and decision boundaries on a less structured problem, individual images can be taken from the MNIST and rectangle test sets and interpolating between them and either an image of a different class or white noise. Along this interpolation the closest point can be found directly on a decision boundary and measured the average pixel difference from the starting image (proportional to the L1 distance).

In an exemplary embodiment, for each sample in the test set correctly predicted by both the ENN and GDN—about 96% of MNIST and 99% of the rectangles-20 target locations can be chosen for interpolation. This target can either be a test image from a different class or white noise (i.e. random black and white pixels) that the networks classified differently than the test image. Interpolating between the sample and the target, the point at which the network changed its predicted class can be found and the average pixel difference can be calculated (which is proportional to the L1 distance to the boundary). The distribution of these distances for each sample are reported.

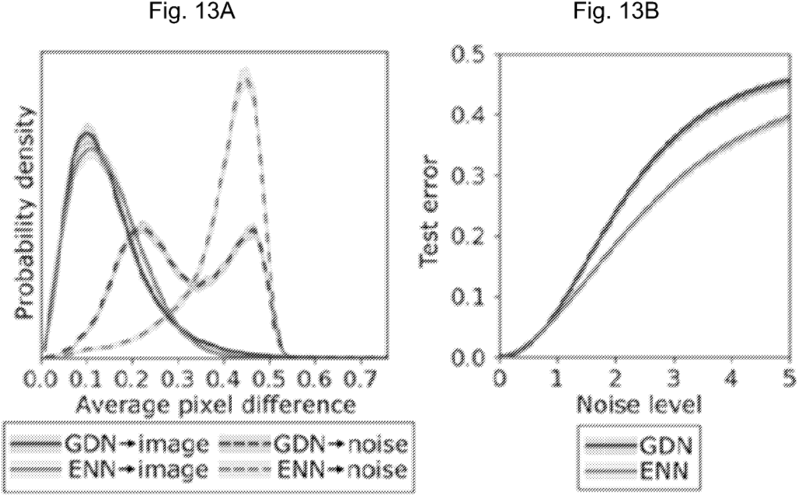

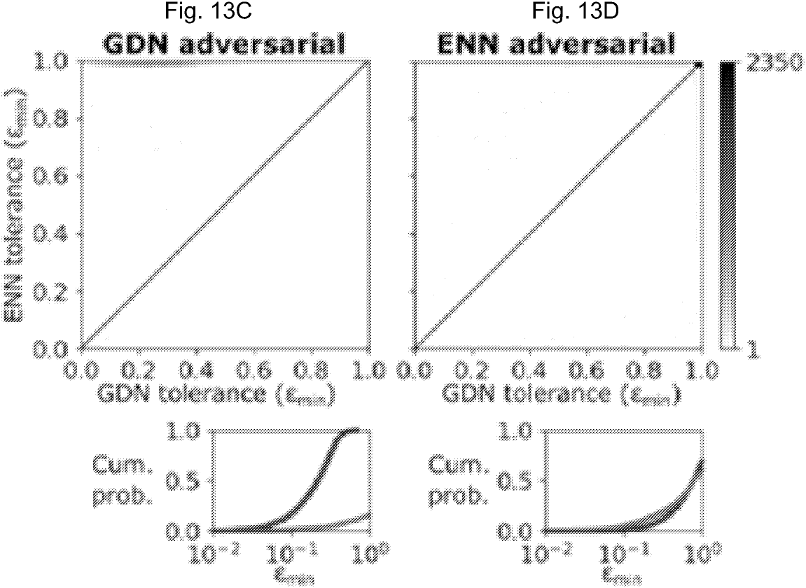

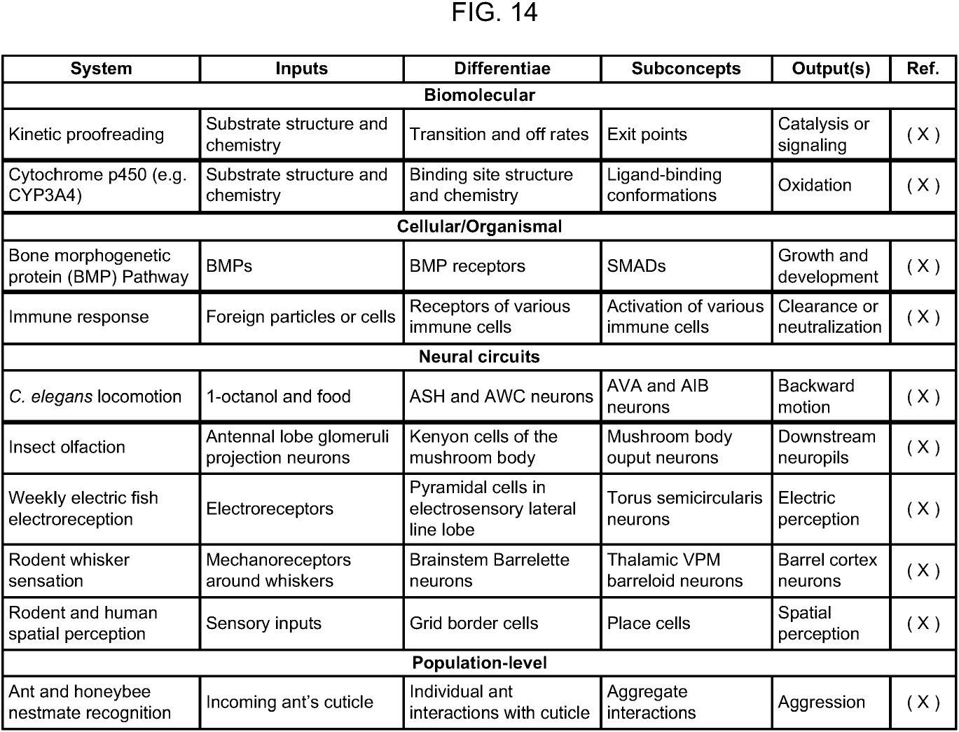

FIG. 13 shows ENNs are robust on the rectangle problem. (Panel A) shows the probability distributions of the average pixel difference between images and a decision boundary, found by interpolating toward either another test images or white noise (with interdecile range shaded). (Panel B) shows the network classification error as Gaussian noise is added to images (with interdecile range shaded). (Panels C-D) show adversarial attacks were generated against both the GDN and ENN for all test images, with the minimum tolerated eₘᵢₙ multiplicative factors shown in these two heatmaps. Inset is the misclassification error at different eₘᵢₙ.

Both GDNs and ENNs space decision boundaries are at about the same distance when interpolating between images. However, when interpolating between images and white noise, ENN decision boundaries are at a greater distance than those of GDNs, suggesting a more robust placement of decision boundaries. FIG. 13, panel E shows that this better spacing of decision boundaries can lead to a greater tolerance of input Gaussian noise by ENNs.

In an exemplary embodiment, the plots in FIG. 13, panel A can be generated by feeding in interpolated function inputs and reporting the output True probability. The plots in FIG. 13, panel B can be found by tracing around this interpolated unit square for all 16 Boolean functions and measuring the difference between the network output and the correct value of the nearest corner.

Moreover, robust decision boundary arrangement can be important when defending against adversarial attacks. FIG. 13 shows adversarial images generated against GDNs and ENNs using the fast gradient sign method. The minimum perturbation (ɛₘᵢₙ) needed for each image to fool its network was then measured. ENNs tolerated attacks of several fold larger than did GDNs. Because adversarial images transfer well between networks, each network was tested on images designed against the other. The results suggested that ENNs are naturally more robust to adversarial attacks.

In an exemplary embodiment, the error rate in classifying the test set can be computed with increasing amounts of noise. For different noise levels, Gaussian noise with a corresponding standard deviation can be added to the test set, and the classification error computed. This can be repeated 20 times for each noise level.

To generate adversarial images, fast gradient sign method (FGSM) can be used, which calculates the sign of the gradient of the loss function L with respect to the inputs x, sign(VₓL), and then scales this vector by a small e until the minimum perturbation to cause misclassification is found, eₘᵢₙ. For both the GDN and ENN we computed sign(VₓL) for each image, with the loss function L for both being the cross-categorical entropy function used to train the GDN. This network-specific perturbation was allowed to scale separately to find eₘᵢₙ for each network.

### Applications

The disclosed techniques (ENNs) can be used in applications requiring legal and business interpretability, AI safety, autonomous self-driving, background checks, forensic/medical diagnoses. The need has been demonstrated by the existence of adversarial inputs that contain human-imperceptible levels of noise, but which GDN’s spectacularly miss-classify. This need can also be evidenced by the unpredictable behaviors of neural networks given certain edge cases. The disclosed ENN will therefore be necessary in all such applications. ENN’s satisfy this because they are built from a classification framework, and the role of each neuron can be understood on an individual level, making the ENN decisions inherently interpretable and amenable to improvement by the relevant parties, who may not be experts in the technical domain of this technique. Future methods using this technique for applications related to interpretability must, by definition, also reveal the use of this technique during the interpretation verification step.

FIG. 14 shows various biological systems interpreted in the ENN framework. In certain cases (e.g. applications involving restricted training sets), the rules of behavior in relevant context (test condition e.g. in vivo) are shared from simpler contexts (training condition e.g. in vitro), yet their manifestations are complex and difficult to interpret in the more realistic setting. The simpler data sets are well-characterized, and high-throughput. Yet, existing approaches do not find such general rules that are applicable to the complex situation because they are essentially pattern-finding and do not generalize if not trained using enough examples from the test condition. ENN’s can be used in these cases to infer intrinsic hidden rules that generalize to the complex setting. This is possible due to the benchmarked performance of ENN and GDN on a set of generalization problems. Specific applications include predicting disease state or drug susceptibility from mutational and/or cell morphology data, as well as inferring brain response to drugs based on fMRI imaging.

Because ENN’s are built from a framework consistent with principles of human cognition from cognitive and experimental neuroscience, ENN’s interpretable and rule-finding performance can be a foundation to build human-like artificial intelligence, for example in software or robotics interfaces, as well as to perform future tasks that are only currently accessible to human brains. ENN’s share “physiological” features with biological neural networks, such as modularity and modular failure patterns (rather than all-or-none failure common with GDN’s).

ENNs can learn underlying rules that allow it to generalize on problem types it has not trained on, and allow the decisions made by ENNs to be understood by humans. Such tasks can include finding robust rules in the mapping from genotype to phenotype; learning rules from in vitro experiments that generalize to an in vivo setting; and in automated tasks that require human interpretability, such as tasks involving legal consequences like navigation, identity fraud, or drug dosage protocols.

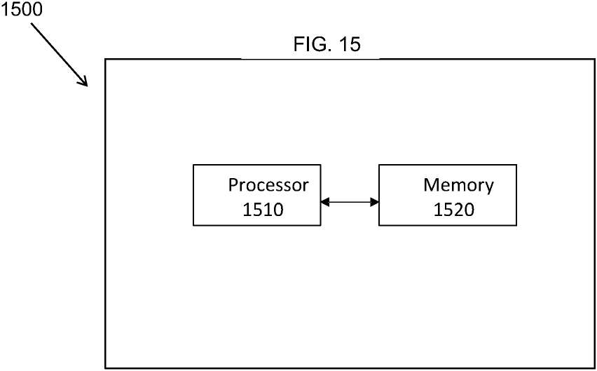

FIG. 15 shows a system 1500 for training a neural network. The system 1500 includes a processor 1510 and an associated memory 1520. The processor 1510 can be configured to obtain a training sample for training the artificial neural network. This aspect of system 1500 can be similar to previously described step 110 of method 100.

The processor 1510 can be configured to determine multiple sub concepts within the training sample. This aspect of system 1500 can be similar to previously described step 120 of method 100. The processor 1510 can be configured to process the sub concepts to obtain differential neurons associated with the sub concepts such that the differential neurons provide a relative distinction between the sub concepts. This aspect is similar to previously described step 130 of method 100.

The processor 1510 can be configured to integrate the differential neurons to obtain sub concepts neurons such that the sub concepts neurons provide an absolute distinction of sub concepts. This aspect is similar to previously described step 140 of method 100. The processor 1510 can be configured to integrate the sub concepts neurons to obtain concept neurons that form an output of the neural network. This aspect is similar to previously described step 150 of method 100.

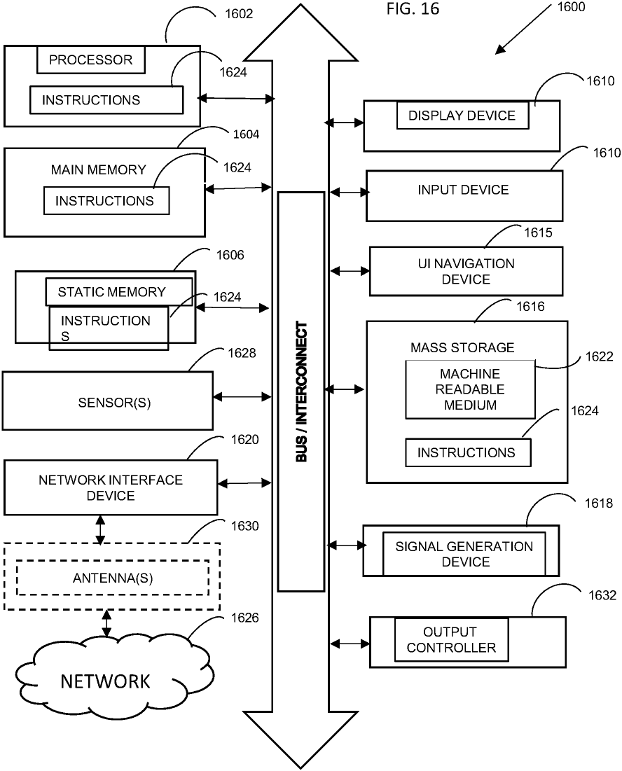

FIG. 16 is a block diagram illustrating an example computing system 1600 upon which any one or more of the methodologies (e.g. method 100 and/or system 1500) herein discussed may be run according to an example described herein. Computer system 1600 may be embodied as a computing device, providing operations of the components featured in the various figures, including components of the method 100, system 1500, or any other processing or computing platform or component described or referred to herein.

In alternative embodiments, the machine can operate as a standalone device or may be connected (e.g., networked) to other machines. In a networked deployment, the machine may operate in the capacity of either a server or a client machine in server-client network environments, or it may act as a peer machine in peer-to-peer (or distributed) network environments.

Example computer system 1600 includes a processor 1602 (e.g., a central processing unit (CPU), a graphics processing unit (GPU) or both), a main memory 1604 and a static memory 1006, which communicate with each other via an interconnect 1608 (e.g., a link, a bus, etc.). The computer system 1000 may further include a video display unit 1610, an input device 1612 (e.g. keyboard) and a user interface (UI) navigation device 1614 (e.g., a mouse). In one embodiment, the video display unit 1610, input device 1612 and UI navigation device 1614 are a touch screen display. The computer system 1600 may additionally include a storage device 1616 (e.g., a drive unit), a signal generation device 1618 (e.g., a speaker), an output controller 1632, and a network interface device 1620 (which may include or operably communicate with one or more antennas 1630, transceivers, or other wireless communications hardware), and one or more sensors 1628.

The storage device 1616 includes a machine-readable medium 1622 on which is stored one or more sets of data structures and instructions 1624 (e.g., software) embodying or utilized by any one or more of the methodologies or functions described herein. The instructions 1624 may also reside, completely or at least partially, within the main memory 1604, static memory 1606, and/or within the processor 1602 during execution thereof by the computer system 1600, with the main memory 1604, static memory 1606, and the processor 1602 constituting machine-readable media.

While the machine-readable medium 1622 is illustrated in an example embodiment to be a single medium, the term “machine-readable medium” may include a single medium or multiple medium (e.g., a centralized or distributed database, and/or associated caches and servers) that store the one or more instructions 1624.

The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions.

The term “machine-readable medium” shall accordingly be taken to include, but not be limited to, solid-state memories, optical media, and magnetic media. Specific examples of machine-readable media include non-volatile memory, including, by way of example, semiconductor memory devices (e.g., Electrically Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

The instructions 1624 may further be transmitted or received over a communications network 1626 using a transmission medium via the network interface device 1620 utilizing any one of several well-known transfer protocols (e.g., HTTP). Examples of communication networks include a local area network (LAN), wide area network (WAN), the Internet, mobile telephone networks, Plain Old Telephone (POTS) networks, and wireless data networks (e.g., Wi-Fi, 3G, and 4G LTE/LTE-A or WiMAX networks).

The term “transmission medium” shall be taken to include any intangible medium that can store, encoding, or carrying instructions for execution by the machine, and includes digital or analog communications signals or other intangible medium to facilitate communication of such software.

Other applicable network configurations may be included within the scope of the presently described communication networks. Although examples were provided with reference to a local area wireless network configuration and a wide area Internet network connection, it will be understood that communications may also be facilitated using any number of personal area networks, LANs, and WANs, using any combination of wired or wireless transmission mediums.

The embodiments described above may be implemented in one or a combination of hardware, firmware, and software. For example, the features in the system architecture 1600 of the processing system may be client-operated software or be embodied on a server running an operating system with software running thereon.

While some embodiments described herein illustrate only a single machine or device, the terms “system”, “machine”, or “device” shall also be taken to include any collection of machines or devices that individually or jointly execute a set (or multiple sets) of instructions to perform any one or more of the methodologies discussed herein.

Examples, as described herein, may include, or may operate on, logic or several components, modules, features, or mechanisms. Such items are tangible entities (e.g., hardware) capable of performing specified operations and may be configured or arranged in a certain manner. In an example, circuits may be arranged (e.g., internally or with respect to external entities such as other circuits) in a specified manner as a module, component, or feature. In an example, the whole or part of one or more computer systems (e.g., a standalone, client or server computer system) or one or more hardware processors may be configured by firmware or software (e.g., instructions, an application portion, or an application) as an item that operates to perform specified operations. In an example, the software may reside on a machine readable medium. In an example, the software, when executed by underlying hardware, causes the hardware to perform the specified operations.

Accordingly, such modules, components, and features are understood to encompass a tangible entity, be that an entity that is physically constructed, specifically configured (e.g., hardwired), or temporarily (e.g., transitorily) configured (e.g., programmed) to operate in a specified manner or to perform part or all operations described herein. Considering examples in which modules, components, and features are temporarily configured, each of the items need not be instantiated at any one moment in time. For example, where the modules, components, and features comprise a general-purpose hardware processor configured using software, the general-purpose hardware processor may be configured as respective different items at different times. Software may accordingly configure a hardware processor, for example, to constitute a particular item at one instance of time and to constitute a different item at a different instance of time.

Additional examples of the presently described method, system, and device embodiments are suggested according to the structures and techniques described herein. Other non-limiting examples may be configured to operate separately or can be combined in any permutation or combination with any one or more of the other examples provided above or throughout the present disclosure.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

1. A computer-implemented method for training an artificial neural network, the method comprising:
obtaining a training sample for training the artificial neural network;
determining multiple sub concepts within the training sample;
processing the sub concepts to obtain differential neurons associated with the sub concepts, wherein the differential neurons provide a relative distinction between the sub concepts;
integrating the differential neurons to obtain sub concepts neurons, wherein the sub concepts neurons provide an absolute distinction of sub concepts; and
integrating the sub concepts neurons to obtain concept neurons that form an output of the neural network.

2. The method of claim 1, wherein the training sample is designed to teach one or more rules.

3. The method of claim 1, wherein the determining of the sub concepts within the training sample includes obtaining various subsets of the training sample and distinguishing between the various subsets.

4. The method of claim 1, wherein unsupervised learning is used to determine hierarchical structure of the sub concepts.

5. The method of claim 1, wherein the sub concepts are overlapping or hierarchically structured.

6. The method of claim 1, wherein one or more of the differential neurons are pruned before the integrating of the differential neurons to obtain sub concepts neurons.

7. The method of claim 1, wherein neurons of the artificial neural network are deliberative, temporarily changing their parameters.

8. The method of claim 1, comprising:
tuning the artificial neural network after the training to improve its performance.

9. The method of claim 1, wherein neurons of the artificial neural network provide symbolic outputs that are interpretable as algorithms.

10. A system for training a neural network, the system comprising a processor and an associated memory, the processor being configured to:
obtain a training sample for training the artificial neural network;
determine multiple sub concepts within the training sample;
process the sub concepts to obtain differential neurons associated with the sub concepts, wherein the differential neurons provide a relative distinction between the sub concepts;
integrate the differential neurons to obtain sub concepts neurons, wherein the sub concepts neurons provide an absolute distinction of sub concepts; and
integrate the sub concepts neurons to obtain concept neurons that form an output of the neural network.

11. The system of claim 10, wherein the training sample is designed to teach one or more rules.

12. The system of claim 10, wherein to determine of the sub concepts within the training sample, the processor is configured to obtain various subsets of the training sample and distinguish between the various subsets.

13. The system of claim 10, wherein unsupervised learning is used to determine hierarchical structure of the sub concepts.

14. The system of claim 10, wherein the sub concepts are overlapping or hierarchically structured.

15. The system of claim 10, wherein one or more of the differential neurons are pruned before the integrating of the differential neurons to obtain sub concepts neurons.

16. The system of claim 10, wherein neurons of the artificial neural network are deliberative, temporarily changing their parameters.

17. The system of claim 10, wherein the processor is configured to tune the artificial neural network after the training to improve its performance.

18. The system of claim 10, wherein neurons of the artificial neural network provide symbolic outputs that are interpretable as algorithms.
